(19) United States
(12) Patent Application Publication
(10) Pub. No.: US 2011/0311271 A1
(43) Pub. Date: Dec. 22, 2011

(54) ELECTROPHOTOGRAPHIC PHOTORECEPTOR, ELECTROPHOTOGRAPHIC CARTRIDGE, AND IMAGE-FORMING APPARATUS

(75) Inventor: Hiroaki TAKAMURA, Kanagawa (JP)

(73) Assignee: MITSUBISHI CHEMICAL CORPORATION, Tokyo (JP)

(21) Appl. No.: 13/155,660

(22) Filed: Jun. 8, 2011

(30) Foreign Application Priority Data
Jun. 17, 2010 (JP) 2010-138448

(51) Int. Cl. G03G 15/00; G03G 21/18; G03G 5/04

(52) U.S. Cl. 399/111; 430/69; 399/159

(57) ABSTRACT

It is to provide an electrophotographic photoreceptor which is excellent in cleaning properties and does not cause a problem of adhesiveness with a substrate in the case where an electrophotographic photoreceptor having a substrate whose outer diameter is small. There are provided an electrophotographic photoreceptor comprising a conductive substrate and a photosensitive layer provided thereon, wherein the conductive substrate has a cylindrical shape having an outer diameter of 25 mm or less and the photosensitive layer contains a copolycarbonate resin having a specific repeating structure as well as an image-forming apparatus having the electrophotographic photoreceptor mounted thereon.

### TECHNICAL FIELD

The present invention relates to an electrophotographic photoreceptor for use in copiers, printers, and the like. More particularly, the invention relates to an electrophotographic photoreceptor having excellent adhesiveness between a conductive substrate and a photosensitive layer and good cleaning properties and capable of downsizing an image-forming apparatus, and an image-forming apparatus having the same mounted thereon.

### BACKGROUND OF THE INVENTION

Since instantaneousness and high-quality images are obtained, electrophotography has been used extensively in the fields of copiers, various printers, and the like.

As electrophotographic photoreceptors serving as the core of electrophotography, use is being made of electrophotographic photoreceptors (hereinafter, also referred to simply as “photoreceptors”) employing an organic photoconductive material which has advantages such as non-polluting properties, ease of film formation, and ease of production.

Electrophotographic photoreceptors employing an organic photoconductive material include: a so-called dispersion type photoreceptor containing photoconductive fine particles dispersed in a binder resin; and a multilayer type photoreceptor having superposed layers including a charge-generating layer and a charge-transporting layer. The multilayer type photoreceptor has the following advantages: the multilayer type photoreceptor can be obtained as a high-sensitivity photoreceptor by using a charge-generating material having a high efficiency in combination with a charge-transporting material having a high efficiency; there is a wide choice of materials and highly safe photoreceptors are obtained; and, since the photosensitive layer can be easily formed by coating, the multilayer type photoreceptor has high productivity and is advantageous also in view of cost. Therefore, the multilayer type photoreceptors are the mainstream of photoreceptors, and have been diligently developed and put to practical use.

Moreover, in recent years, electrophotographic printers and MFP have been also used in SOHO uses and domestic uses, so that demands for space saving and downsizing have increased as before and a trend of downsizing of the printers has been accelerated. When the outer diameter of the electrophotographic photoreceptor decreases, cleaning with a cleaning blade becomes difficult and hence troubles such as insufficient cleaning and filming are prone to occur. Particularly, in the case where the outer diameter of the substrate is 25 mm or less, this trend is remarkable, so that it becomes an important factor to control surface properties of the photosensitive layer.

In the case of common photoreceptors having no functional layer such as a surface protective layer, a layer in contact with the cleaning blade is the photosensitive layer.

As binder resins for the photosensitive layer, use is being made of vinyl polymers such as poly(methyl methacrylate), polystyrene, and polyvinyl chloride and copolymers thereof, thermoplastic resins such as polycarbonate, polyester, polysulfone, phenoxy, epoxy, and silicone resins, and various thermosetting resins. Of the numerous binder resins, polycarbonate resins have relatively excellent performance and thus various polycarbonate resins have hitherto been developed and put to practical use (e.g., see Patent Documents 1 to 4).

### DOCUMENT LIST

[Patent Document 1] JP-A-50-98332

[Patent Document 2] JP-A-59-71057

[Patent Document 3] JP-A-59-184251

[Patent Document 4] JP-A-5-21478

Hitherto, for downsizing an image-forming apparatus, there has existed a method of using an electrophotographic photoreceptor having a small outer diameter. However, the small diameter means that a large curvature is imparted upon heat shrinkage at drying of the coated photosensitive layer and is a disadvantageous direction from the standpoint of adhesiveness between the photosensitive layer and the substrate.

Accordingly, even in the case of a binder resin for photosensitive layer excellent in cleaning properties, there is a case where it is not usable for real use because of adhesiveness.

### SUMMARY OF THE INVENTION

Namely, an object of the present invention is to provide an electrophotographic photoreceptor which is excellent in cleaning properties and does not cause the problem of adhesiveness with the substrate in the case where an electrophotographic photoreceptor having a substrate whose outer diameter is small.

The present inventors diligently made investigations. As a result, they have found that cleaning properties are excellent and no problem occurs on adhesiveness with the substrate in the case where a photoreceptor containing a polycarbonate resin having a specific structure is applied to an electrophotographic photoreceptor having a substrate outer diameter of 25 mm or less. The invention has been thus completed.

Namely, the gist of the invention lies on thee followings.

(1) An electrophotographic photoreceptor comprising a conductive substrate and a photosensitive layer provided thereon, wherein the conductive substrate has a cylindrical shape having an outer diameter of 25 mm or less and the photosensitive layer contains a copolycarbonate resin having a repeating structure represented by the following general formula (1).

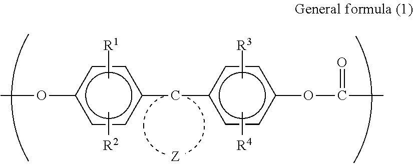

In formula (1), R¹, R², R³ and R⁴ each independently represent a hydrogen atom or an alkyl group having 4 or less carbon atoms, Z forms a saturated cyclic aliphatic alkyl group having 5 to 8 carbon atoms including the carbon atom to be bonded, and the saturated cyclic aliphatic alkyl group has one to three methyl groups as substituent(s).

(2) The electrophotographic photoreceptor according to (1), wherein the copolycarbonate resin is a copolymer of the repeating structure represented by the above general formula (1) and a repeating structure represented by the following structural formula (2):

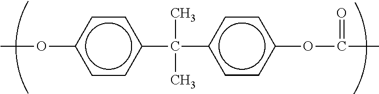

(3) The electrophotographic photoreceptor according to (2), wherein, in the copolycarbonate resin, the molar ratio of the repeating structure represented by the above structural formula (2) is larger than the molar ratio of the repeating structure represented by the following general formula (1).

(4) The electrophotographic photoreceptor according to (3), wherein, in the copolycarbonate resin, the molar ratio of the repeating structure represented by the above structural formula (2) is twice or more the molar ratio of the repeating structure represented by the following general formula (1).

(5) The electrophotographic photoreceptor according to any one of (1) to (4), wherein the above general formula (1) is represented by the following structural formula (3):

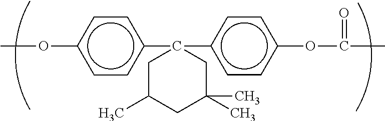

(6) The electrophotographic photoreceptor according to any one of (1) to (5), wherein the outer diameter of the conductive substrate is 22 mm or less.

(7) An image-forming apparatus comprising: the electrophotographic photoreceptor according to any one of (1) to (6); a charging unit which charges the electrophotographic photoreceptor; an exposure unit which exposes the charged electrophotographic photoreceptor to light to form an electrostatic latent image; a developing unit which develops the electrostatic latent image with a toner; and a transfer unit which transfers the toner to a receiving object.

(8) An electrophotographic cartridge comprising: the electrophotographic photoreceptor according to any one of (1) to (6); and at least one member selected from a charging unit which charges the electrophotographic photoreceptor, an imagewise-exposure unit which imagewise exposes the charged electrophotographic photoreceptor to light to form an electrostatic latent image, a developing unit which develops the electrostatic latent image with a toner, a transfer unit which transfers the toner to a receiving object, and a cleaning unit which recovers the toner adherent to the electrophotographic photoreceptor.

According to the invention, even in the case of using electrophotographic photoreceptors having a substrate outer diameter of 25 mm or less, electrophotographic photoreceptors having excellent cleaning properties and occurring no problem on adhesiveness with a substrate can be obtained and also a downsized image-forming apparatus can be obtained.

### BRIEF DESCRIPTION OF THE DRAWINGS

FIG. 1 is a diagrammatic view illustrating the constitution of important parts of one embodiment of the image-forming apparatus of the invention.

FIG. 2 is an X-ray diffraction pattern illustrating a powder X-ray diffraction spectrum of the oxytitanium phthalocyanine used in Examples and Comparative Examples of the invention.

FIG. 3 is an X-ray diffraction pattern illustrating a powder X-ray diffraction spectrum of the oxytitanium phthalocyanine used in Examples and Comparative Examples of the invention.

### DESCRIPTION OF REFERENCE NUMERALS AND SIGNS

1 Photoreceptor
2 Charging device (charging roller)
3 Exposure device
4 Developing device
5 Transfer device
6 Cleaner
7 Fixing device
41 Developing vessel
42 Agitator
43 Feed roller
44 Developing roller
45 Control member
71 Upper fixing member (pressure roller)
72 Lower fixing member (fixing roller)
73 Heater
T Toner
P Recording paper (paper, medium)

### DETAILED DESCRIPTION OF THE INVENTION

Best modes for carrying out the invention will be explained below in detail. The invention should not be construed as being limited to the following embodiments, and various modifications of the invention can be made within the spirit of the invention.

In the photosensitive layer of the electrophotographic photoreceptor of the invention, a polycarbonate resin having a specific structure is used as a binder resin of the photosensitive layers to be mounted on the conductive substrate of the photoreceptor.

The specific constitution of the photosensitive layer of the invention includes a multilayer type photoreceptor formed by superposing, on a conductive substrate, a charge-generating layer including a charge-generating material as a main component and a charge-transporting layer including a charge-transporting material and a binder resin as main components; and a dispersion type (single-layer type) photoreceptor having a photosensitive layer which is formed on a conductive substrate and which includes a charge-transporting material and a binder resin and contains a charge-generating material dispersed therein. In the invention, the binder resin is used preferably in the charge-transporting layer of the multilayer type photosensitive layer.

<Polycarbonate Resin>

The photosensitive layer of the electrophotographic photoreceptor of the invention contains a copolycarbonate resin having a repeating structure represented by the following general formula (1):

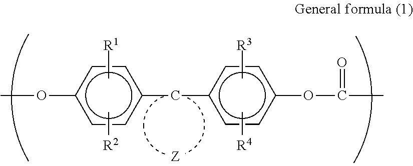

wherein in formula (1), R¹, R², R³ and R⁴ each independently represent a hydrogen atom or an alkyl group having 4 or less carbon atoms, Z forms a saturated cyclic aliphatic alkyl group having 5 to 8 carbon atoms including the carbon atom to be bonded, and the saturated cyclic aliphatic alkyl group has one to three methyl groups as substituent(s).

Moreover, as a copolymerization component of a repeating structure represented by the above general formula (1), a repeating structure represented by the following general formula (2) is preferred. Furthermore, the above general formula (1) is preferably represented by the following structural formula (3).

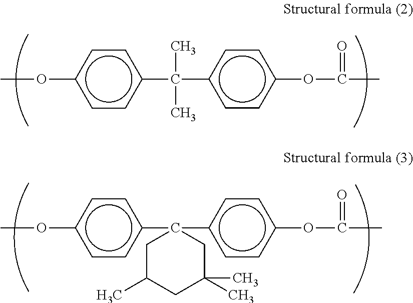

Moreover, the above general formula (1) is particularly preferably represented by the following structural formula (4). With regard to m and n, m is preferably less than n and further, 2 m is preferably equal to or less than n.

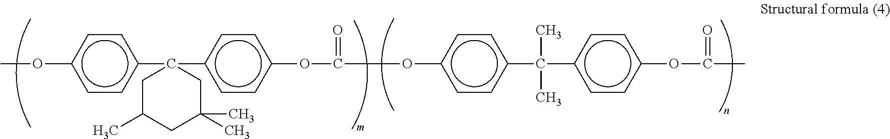

In the polycarbonate resin including a repeating structure represented by general formula (1), the viscosity-average molecular weight in each case is generally 10,000 or higher, preferably 15,000 or higher, more preferably 20,000 or higher, and is generally 300,000 or lower, preferably 200,000 or lower, more preferably 100,000 or lower, so that the resin is suitable for forming a photosensitive layer through coating fluid application. When the viscosity-average molecular weight thereof is lower than 10,000, this resin has reduced mechanical strength and is impracticable. When the viscosity-average molecular weight thereof exceeds 300,000, it is difficult to form a photosensitive layer having an appropriate thickness through coating.

The aforementioned resin of the invention is used in an electrophotographic photoreceptor and is used as a binder resin in the photosensitive layer to be mounted on the conductive substrate of the photoreceptor.

### <Other Resins>

In the invention, other resins may be used in combination with the polycarbonate resin containing the repeating structure represented by the general formula (1).

The resins to be used in combination include vinyl polymers such as poly(methyl methacrylate), polystyrene, and polyvinyl chloride and copolymers thereof, thermoplastic resins such as polycarbonate, polyester, polysulfone, phenoxy, epoxy, and silicone resins, and various thermosetting resins. Of these resins, polycarbonate resins and polyester resins are preferred. The mixing ratio of the resins to be used in combination is not particularly limited but, in order to obtain the advantage of the invention sufficiently, the other resins are preferably used within the range not exceeding the ratio of the polycarbonate resin of the formula (1) and particularly, the other resins are preferably not used in combination.

### <Conductive Substrate>

The conductive substrate for use in the invention is characterized in that the substrate has a cylindrical shape and has an outer diameter of 25 mm or less. Moreover, the outer diameter is preferably 22 mm or less, more preferably 20 mm or less from the standpoint of exhibiting an excellent advantage of the invention.

As materials of the conductive substrate, use is mainly made of for example, a metallic material such as aluminum, an aluminum alloy, stainless steel, copper, and nickel, a resinous material to which conductivity has been imparted by adding a conductive powder of, e.g., a metal, carbon, or tin oxide, or a resin, glass, or paper having a conductive material such as aluminum, nickel, or ITO (indium-tin oxide) vapor-deposited or applied on a surface thereof. With respect to shape, the conductive substrate may have any shape so far as it has a cylindrical shape, and one in a drum, sheet, or belt form or the like may be used. A substrate obtained by coating a conductive substrate made of a metallic material with a conductive material having a suitable value of resistance in order to regulate conductivity, surface properties, or the like and to hide defects may also be used.

In the case where a metallic material such as an aluminum alloy is used as the conductive substrate, this material may be used after having been subjected to anodization, a treatment for forming chemical conversion coating, etc. In the case where anodization is conducted, it is desirable to subject the anodized substrate to a pore-filling treatment by a known method.

The surface of the substrate may be smooth or may have been roughened by a special grinding technique or polishing treatment. Furthermore, a conductive substrate having a roughened surface imparted thereto by incorporating particles of a suitable particle diameter into the material constituting the substrate may also be used.

### <Undercoat Layer>

An undercoat layer may be disposed between the conductive substrate and the photosensitive layer in order to improve adhesiveness, nonblocking properties, etc.

As the undercoat layer, use may be made of a resin, a material obtained by dispersing particles of, e.g., a metal oxide in a resin, or the like. Examples of the metal oxide particles for use in the undercoat layer include particles of a metal oxide containing one metallic element, such as titanium oxide, aluminum oxide, silicon oxide, zirconium oxide, zinc oxide, or iron oxide, and particles of a metal oxide containing two or more metallic elements, such as calcium titanate, strontium titanate, or barium titanate. Metal oxide particles of one kind only may be used, or a mixture of two or more kinds of metal oxide particles may be used. Preferred of these particulate metal oxides are titanium oxide and aluminum oxide. Particularly preferred is titanium oxide. The titanium oxide particles may be ones in which the surface thereof has undergone a treatment with an inorganic substance, e.g., tin oxide, aluminum oxide, antimony oxide, zirconium oxide, or silicon oxide, or with an organic substance, e.g., stearic acid, a polyol, or a silicone. The crystal form of the titanium oxide particles may be any of rutile, anatase, brookite, and amorphous. Two or more crystalline states may be included.

With respect to particle diameter, metal oxide particles having various particle diameters can be used. However, metal oxide particles having a particle diameter of from 10 nm to 100 nm in terms of average primary-particle diameter are preferred from the standpoints of properties and liquid stability. Particularly preferred are metal oxide particles having a particle diameter of from 10 nm to 50 nm.

It is desirable that an undercoat layer should be formed so as to be constituted of a binder resin and metal oxide particles dispersed in the resin. As the binder resin for use in the undercoat layer, use may be made of a phenoxy, epoxy, polyvinylpyrrolidone, poly(vinyl alcohol), casein, poly(acrylic acid), cellulose derivative, gelatin, starch, polyurethane, polyimide, polyamide, or the like. Such a polymer can be used alone or in a cured form obtained with a curing agent. Of these, an alcohol-soluble copolyamide, modified polyamide, or the like is preferred because such polyamides show satisfactory dispersibility and applicability.

The proportion of the inorganic particles to be added to the binder resin can be selected at will. However, from the standpoints of the stability and applicability of the dispersion, it is preferred to use the inorganic particles in an amount ranging from 10% by weight to 500% by weight.

The thickness of the undercoat layer can be selected at will. However, the thickness thereof is preferably from 0.1 μm to 25 μm from the standpoints of photoreceptor characteristics and applicability. A known antioxidant and the like may be added to the undercoat layer.

### <Charge-Generating Layer>

In the case where the electrophotographic photoreceptor of the invention is of the multilayer type, examples of charge-generating materials usable in the charge-generating layer thereof include various photoconductive materials such as selenium and alloys thereof, cadmium sulfide, and other inorganic photoconductive materials, and organic pigments including phthalocyanine pigments, azo pigments, quinacridone pigments, indigo pigments, perylene pigments, polycyclic quinone pigments, anthanthrone pigments, and benzimidazole pigments. Of these, organic pigments are preferred. In particular, phthalocyanine pigments and azo pigments are preferred. Particles of these charge-generating materials are used in the state of being bound with various binder resins such as, e.g., polyester resins, poly(vinyl acetate), poly(acrylic ester)s, poly(methacrylic ester)s, polyesters, polycarbonates, poly(vinyl acetoacetal), poly(vinyl propional), poly(vinyl butyral), phenoxy resins, epoxy resins, urethane resins, cellulose esters, and cellulose ethers. In this case, a charge-generating material may be used in such a proportion that the amount of the charge-generating material is in the range of from 30 parts by weight to 500 parts by weight per 100 parts by weight of the binder resin. A suitable film thickness thereof is generally from 0.1 μm to 1 μm, preferably from 0.15 μm to 0.6 μm.

In the case where a phthalocyanine compound is used as a charge-generating material, use may be made of metal-free phthalocyanines and phthalocyanine compounds to which a metal, e.g., copper, indium, gallium, tin, titanium, zinc, vanadium, silicon, or germanium, or an oxide, halide, or another form of the metal has coordinated. Examples of ligands for metal atoms having a valence of 3 or higher include an oxygen atom, a chlorine atom, a hydroxyl group, and an alkoxy group. Especially suitable are X-form and τ-form metal-free phthalocyanines, which have high sensitivity, A-form, B-form, D-form, and other titanyl phthalocyanines, vanadyl phthalocyanines, chloroindium phthalocyanines, chlorogallium phthalocyanines, and hydroxygallium phthalocyanines. Of the crystal forms of titanyl phthalocyanines shown above, the A-form and B-form were referred to as I-phase and II-phase, respectively, by W. Heller et al. (Zeit. Kristallogr., 159 (1982) 173), and the A-form is known as a stable form. The D-form is a crystal form characterized by showing a distinct peak at a diffraction angle 2θ±0.2° of 27.3° in powder X-ray diffractometry using a CuKα line. A single phthalocyanine compound may be used alone, or some phthalocyanine compounds may be used in the state of being mixed with each other. In the case where phthalocyanine compounds are to be used in a mixed state, the constituent elements may be mixed later together and used. Alternatively, the phthalocyanine compounds may be ones the mixed state of which was generated in a production/treatment step of the phthalocyanine compounds, such as, e.g., synthesis, pigment formation, or crystallization. Known as such treatments are an acid paste treatment, grinding, solvent treatment, and the like.

### <Charge-Transporting Layer>

In the case where an embodiment of the invention is of the multilayer type, the charge-transporting layer contains a charge-transporting material and other component(s) that may be used in combination as needed, together with the binder resin including the polycarbonate resin in the invention. The charge-transporting layer may be specifically obtained as follows. For example, the charge-transporting material and the like and the binder resin are dissolved or dispersed in a solvent to prepare a coating fluid, which is then applied onto a charge-generating layer in the case of a normal multilayer type photosensitive layer or applied on a conductive substrate (on an undercoat layer in the case where the undercoat layer is provided) in the case of a reverse multilayer type photosensitive layer, followed by drying.

The charge-transporting material is not particularly limited and any material can be used. Examples of known charge-transporting materials include electron-attracting materials such as aromatic nitro compounds, e.g., 2,4,7-trinitrofluorenone, cyano compounds, e.g., tetracyanoquinodimethane, and quinone compounds, e.g., diphenoquinone, heterocyclic compounds such as carbazole derivatives, indole derivatives, imidazole derivatives, oxazole derivatives, pyrazole derivatives, thiadiazole derivatives, and benzofuran derivatives, and electron-donating materials such as aniline derivatives, hydrazone derivatives, aromatic amine derivatives, stilbene derivatives, butadiene derivatives, enamine derivatives, compounds constituted of two or more of these compounds bonded to each other, and polymers having, in the main chain or side chains thereof, a group derived from any of these compounds. Preferred of these are carbazole derivatives, hydrazone derivatives, aromatic amine derivatives, stilbene derivatives, butadiene derivatives, enamine derivatives, and compounds constituted of two or more of these compounds bonded to each other. Any one of these charge-transporting materials may be used alone or two or more thereof may be used in any combination.

Such charge-transporting material is bound with a binder resin including a polycarbonate resin of the invention to form a charge-transporting layer. The charge-transporting layer may be constituted of a single layer, or may be composed of superposed layers differing in component or composition.

The proportion of the charge-transporting material to the binder resin is 20 parts by weight or larger per 100 parts by weight of the binder resin. The proportion is preferably 30 parts by weight or larger from the standpoint of reduction of residual potential and more preferably 40 parts by weight or larger from the standpoints of stability and degree of charge transfer at repeated use, per 150 parts by weight of the binder resin. On the other hand, from the standpoint of thermal stability of the photosensitive layer, the charge-transporting material is generally used in a proportion of 150 parts by weight or smaller. Particularly, the proportion is preferably 110 parts by weight or smaller from the standpoint of compatibility of the charge-transporting material with the binder resin, more preferably 80 parts by weight or smaller from the standpoint of printing resistance, and most preferably 70 parts by weight or smaller from the standpoint of scratching resistance.

The film thickness of the charge-transporting layer is not particularly limited but is generally from 5 μm or larger, preferably 10 μm or larger, and usually 50 μm or smaller, preferably 45 μm or smaller, and more preferably 30 μm or smaller from the viewpoints of long life, image stability, and further high resolution.

Well-known additives such as a plasticizer, antioxidant, an ultraviolet absorber, an electron-attracting compound, a dye, a pigment, and a leveling agent may be incorporated into the charge-transporting layer in order to improve film-forming properties, flexibility, applicability, fouling resistance, gas resistance, light resistance, etc. Examples of the antioxidant include hindered phenol compounds and hindered amine compounds. Examples of the dye and pigment include various colorant compounds and azo compounds.

### <Dispersion Type (Single-Layer Type) Photosensitive Layer>

In the case of dispersion type photosensitive layer, the charge-generating material described above is dispersed in a charge-transporting medium having a composition such as that shown above.

In this case, it is necessary that the charge-generating material should have a sufficiently small particle diameter and the charge-generating material is used in a particle diameter of preferably 1 μm or smaller, more preferably 0.5 μm or smaller. In the case where the amount of the charge-generating material to be dispersed in the photosensitive layer is too small, sufficient sensitivity is not obtained. Too large amounts thereof exert an adverse influence to result in a decrease in electrification characteristics, decrease in sensitivity, etc. For example, the charge-generating material is used in an amount preferably in the range of from 0.5% by weight to 50% by weight, more preferably in the range of from 1% by weight to 20% by weight.

The thickness of the photosensitive layer is generally from 5 μm to 50 μm, more preferably from 10 μm to 45 μm. In this case also, a known plasticizer for improving film-forming properties, flexibility, mechanical strength, etc., an additive for reducing residual potential, a dispersion aid for improving dispersion stability, a leveling agent or surfactant for improving applicability, and other additives such as, e.g., a silicone oil or fluorochemical oil may have been added.

A protective layer may be formed on the photosensitive layer for the purposes of preventing the photosensitive layer from wearing and of preventing/diminishing the deterioration of the photosensitive layer caused by, e.g., a product of discharge generated from charging devices, etc.

A surface layer may contain a fluororesin, silicone resin, or the like for the purpose of reducing the frictional resistance or wear of the photoreceptor surface. The surface layer may contain particles of any of these resins or particles of an inorganic compound.

### <Method of Preparing Electrophotographic Photoreceptor>

The method of preparing an electrophotographic photoreceptor to which the present embodiment is to be applied is not particularly limited. Usually, each layer constituting the photoreceptor may be formed by application on a conductive substrate by a known technique such as dip coating, spray coating, nozzle coating, bar coating, roll coating, or blade coating known as methods of forming a photosensitive layer of an electrophotographic photoreceptor. Of these, dip coating is preferred from the standpoint of high productivity.

As forming methods of individual layers, known methods including successively applying coating fluids obtained by dissolving or dispersing in a solvent the materials to be incorporated into layers. <Image-Forming Apparatus>

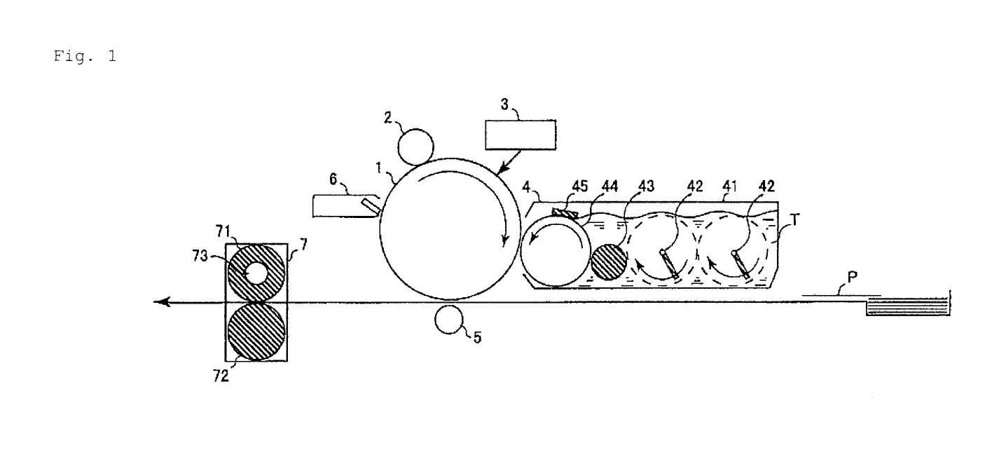

The image-forming apparatus for use in the invention is explained below by reference to FIG. 1, which illustrates the constitution of important parts of the apparatus. However, embodiments thereof should not be construed as being limited to those explained below, and the apparatus can be modified at will so long as the modifications do not depart from the spirit of the invention.

As shown in FIG. 1, the image-forming apparatus includes an electrophotographic photoreceptor 1, a charging device 2, an exposure device 3, a developing device 4, and a transfer device 5, and the apparatus may further has a cleaner 6 and a fixing device 7 according to need.

The electrophotographic photoreceptor 1 is not particularly limited so far as it is any of the electrophotographic photoreceptors of the invention described above. FIG. 1 shows, as an example thereof, a drum-shaped photoreceptor constituted of a cylindrical conductive substrate and, formed on the surface thereof, the photosensitive layer described above. The charging device 2, exposure device 3, developing device 4, transfer device 5, and cleaner 6 have been disposed along the peripheral surface of this electrophotographic photoreceptor 1.

The charging device 2 serves to charge the electrophotographic photoreceptor 1. It evenly charges the surface of the electrophotographic photoreceptor 1 to a given potential. FIG. 1 shows a roller type charging device (charging roller) as an example of the charging device 2. However, corona charging devices such as corotrons and scorotrons, contact type charging devices such as charging brushes, and the like are frequently used besides the charging rollers.

In many cases, the electrophotographic photoreceptor 1 and the charging device 2 have been designed to constitute a cartridge (hereinafter suitably referred to as “photoreceptor cartridge”) which involves these two members and is designed to be removable from the main body of the image-forming apparatus. Also in the invention, it is desirable to use the apparatus in such a form. When, for example, the electrophotographic photoreceptor 1 and the charging device 2 have deteriorated, this photoreceptor cartridge can be removed from the main body of the image-forming apparatus and a fresh photoreceptor cartridge can be mounted in the main body of the image-forming apparatus. Also with respect to the toner, which will be described later, the toner in many cases has been designed to be stored in a toner cartridge and be removable from the main body of the image-forming apparatus. When the toner in the toner cartridge in use has run out, this toner cartridge can be removed from the main body of the image-forming apparatus and a fresh toner cartridge can be mounted. Furthermore, there are cases where a cartridge including all of the electrophotographic photoreceptor 1, a charging device 2, and a toner is used. As described later, the toner of the invention described above is used as a toner in the image-forming apparatus.

The exposure device 3 is not particularly limited in kind so far as it can illuminate the electrophotographic photoreceptor 1 and thereby form an electrostatic latent image in the photosensitive surface of the electrophotographic photoreceptor 1. Specific examples thereof include halogen lamps, fluorescent lamps, lasers such as semiconductor lasers and He—Ne lasers, and LEDs. It is also possible to conduct exposure by the technique of internal photoreceptor exposure. Although any desired light can be used for exposure, for example, the monochromatic light having a wavelength of 780 nm, a monochromatic light having a slightly short wavelength of 600 to 700 nm, a monochromatic light having a short wavelength of 380 to 600 nm, or the like may be used to conduct exposure.

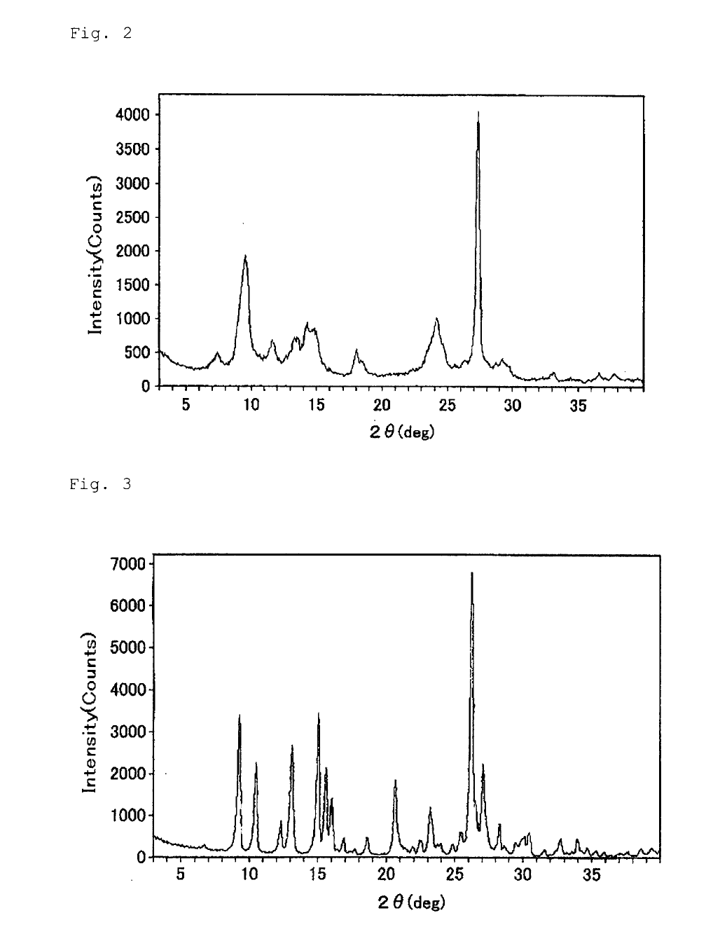

The developing device 4 is not particularly limited in kind and any devices such as ones operated by a dry development technique, e.g., cascade development, development with one-component conductive toner, or two-component magnetic brush development, a wet development technique, etc. can be used. In FIG. 2, the developing device 4 includes a developing chamber 41, agitators 42, a feed roller 43, a developing roller 44, and a control member 45. This device has such a constitution that a toner T is stored in the developing chamber 41. According to need, the developing device 4 may be equipped with a replenishing device (not shown) for replenishing the toner T. This replenishing device has such a constitution that the toner T can be supplied from a container such as a bottle or cartridge.

The feed roller 43 is made of an electrically conductive sponge, etc. The developing roller 44 is constituted of a metallic roll made of iron, stainless steel, aluminum, nickel, or the like or a resinous roll obtained by coating such a metallic roll with a silicone resin, urethane resin, fluororesin, or the like. The surface of this developing roller 44 may be subjected to a surface-smoothing processing or surface-roughening processing according to need.

The developing roller 44 is disposed between the electrophotographic photoreceptor 1 and the feed roller 43 and is in contact with each of the electrophotographic photoreceptor 1 and the feed roller 43. The feed roller 43 and the developing roller 44 are rotated by a rotation driving mechanism (not shown). The feed roller 43 holds the toner T stored and supplies it to the developing roller 44. The developing roller 44 holds the toner T supplied by the feed roller 43 and brings it into contact with the surface of the electrophotographic photoreceptor 1.

The control member 45 is constituted of a resinous blade made of a silicone resin, urethane resin, or the like, a metallic blade made of stainless steel, aluminum, copper, brass, phosphor bronze, or the like, a blade obtained by coating such a metallic blade with a resin, etc. This control member 45 usually is in contact with the developing roller 44 and is pushed against the developing roller 44 with a spring or the like at a given force (the linear blade pressure is generally 0.05 to 5 N/cm). According to need, this control member 45 may have the function of charging the toner T based on electrification by friction with the toner T.

The agitators 42 are each rotated by the rotation driving mechanism. They agitate the toner T and convey the toner T to the feed roller 43 side. Two or more agitators 42 differing in blade shape, size, etc. may be disposed.

The transfer device 5 is not particularly limited in kind, and use can be made of a device operated by any desired technique selected from an electrostatic transfer technique, pressure transfer technique, adhesive transfer technique, and the like, such as corona transfer, roller transfer, and belt transfer. Here, the transfer device 5 is one constituted of a transfer charger, transfer roller, transfer belt, or the like disposed so as to face the electrophotographic photoreceptor 1. A given voltage (transfer voltage) which has the polarity opposite to that of the charge potential of the toner T is applied to the transfer device 5, and this transfer device 5 thus transfers the toner image formed on the electrophotographic photoreceptor 1 to a receiving material (paper or medium) P.

The cleaner 6 is not particularly limited, and any desired cleaner can be used, such as a brush cleaner, magnetic brush cleaner, electrostatic brush cleaner, magnetic roller cleaner, or blade cleaner. From the standpoint of effectiveness, the blade cleaner is preferred. The cleaner 6 serves to scrape off the residual toner adherent to the photoreceptor 1 with a cleaning member and thus recover the residual toner.

The fixing device 7 is constituted of an upper fixing member (pressure roller) 71 and a lower fixing member (fixing roller) 72. The fixing member 71 or 72 is equipped with a heater 73 inside. FIG. 1 shows an example in which the upper fixing member 71 is equipped with a heater 73 inside. As the upper and lower fixing members 71 and 72, there can be used a known heat-fixing member such as a fixing roll obtained by coating a metallic tube made of stainless steel, aluminum, or the like with a silicone rubber, a fixing roll obtained by further coating that fixing roll with a fluororesin, or a fixing sheet. Furthermore, the fixing members 71 and 72 each may have a constitution in which a release agent such as a silicone oil is supplied thereto in order to improve release properties, or may have a constitution in which the two members are forcedly pressed against each other with a spring or the like.

The toner which has been transferred to the recording paper P passes through the nip between the upper fixing member 71 heated at a given temperature and the lower fixing member 72, during which the toner is heated to a molten state. After the passing, the toner is cooled and fixed to the recording paper P.

The fixing device also is not particularly limited in kind. Fixing devices which can be mounted include ones operated by any desired fixing technique, such as heated-roller fixing, flash fixing, oven fixing, or pressure fixing, besides the device used here.

In the image-forming apparatus having the constitution described above, image recording is conducted in the following manner. First, the surface (photosensitive surface) of the photoreceptor 1 is charged to a given potential (e.g., −600 V) by the charging device 2. This charging may be conducted with a direct-current voltage or with a direct-current voltage on which an alternating-current voltage has been superimposed.

Subsequently, the charged photosensitive surface of the photoreceptor 1 is exposed by the exposure device 3 according to the image to be recorded. Thus, an electrostatic latent image is formed in the photosensitive surface. This electrostatic latent image formed in the photosensitive surface of the photoreceptor 1 is developed by the developing device 4.

In the developing device 4, the toner T fed by the feed roller 43 is formed into a thin layer with the control member (developing blade) 45 and, simultaneously therewith, frictionally charged so as to have a given polarity (here, the toner is charged so as to have negative polarity, which is the same as the polarity of the charge potential of the photoreceptor 1). This toner T is conveyed while being held by the developing roller 44 and is brought into contact with the surface of the photoreceptor 1.

When the charged toner T held on the developing roller 44 comes into contact with the surface of the photoreceptor 1, a toner image corresponding to the electrostatic latent image is formed on the photosensitive surface of the photoreceptor 1. This toner image is transferred to a recording paper P by the transfer device 5. Thereafter, the toner which has not been transferred and remains on the photosensitive surface of the photoreceptor 1 is removed by the cleaner 6.

After the transfer of the toner image to the recording paper P, this recording paper P is passed through the fixing device 7 to thermally fix the toner image to the recording paper P. Thus, a finished image is obtained.

Since the image-forming apparatus of the present embodiment uses the photoreceptor of the invention, it is possible to downsize the apparatus and also it is possible to realize high image quality of the images formed without generating insufficient cleaning.

Incidentally, the image-forming apparatus may have a constitution in which an erase step, for example, can be conducted, in addition to the constitution described above. The erase step is a step in which the electrophotographic photoreceptor is exposed to a light to thereby erase the residual charges from the electrophotographic photoreceptor. As an eraser, there may be used a fluorescent lamp, LED, or the like. The light to be used in the erase step, in many cases, is a light having such an intensity that the exposure energy thereof is at least 3 times the energy of the exposure light.

The constitution of the image-forming apparatus may be further modified. For example, the apparatus may have a constitution in which steps such as an auxiliary charging step can be conducted, or have a constitution in which offset printing is conducted. Furthermore, the apparatus may have a full-color tandem constitution employing two or more toners.

### EXAMPLES

The embodiment will be explained below more specifically with reference to Examples. The following Examples are given in order to explain the invention in detail, and the invention should not be construed as being limited to the following Examples unless the invention departs from the spirit thereof. Each “parts” described in the following Examples and Comparative Examples means “parts by weight” unless otherwise indicated.

The measurement of the viscosity-average molecular weight of the polycarbonate resin is explained here.

A polyester resin is dissolved in dichloromethane to prepare a solution having a concentration C of 6.00 g/L. Using an Ubbelohde capillary viscometer having a solvent (dichloromethane) flow time t₀ of 136.16 seconds, the sample solution is examined for flow time t in a thermostatic water bath set at 20.0° C. The viscosity-average molecular weight Mv is calculated according to the following equations.

a=0.438×ηₛₚ+1 ηₛₚ=t/t₀−1

b=100×ηₛₚ/C C=6.00 (g/L)

η=b/a

Mv=3207×η^{1.205}

### <Production of Photoreceptor Drum>

### Example 1

Rutile titanium oxide having an average primary-particle diameter of 40 nm (“TTO55N” manufactured by Ishihara Sangyo Kaisha, Ltd.) and methyldimethoxysilane were mixed in a ball mill and the resultant slurry was dried, the amount of the silane being 3% by weight based on the titanium oxide. Then, the slurry was washed with methanol and dried and the hydrophobized titanium oxide obtained was dispersed in methanol/1-propanol with a ball mill to thereby form a dispersion slurry of the hydrophobized titanium oxide. This dispersion slurry was mixed with a mixed solvent of methanol/1-propanol/toluene (weight ratio: 7/1/2) and with pellets of a copolyamide composed of ε-caprolactam/bis(4-amino-3-methylcyclohexyl)methane/hexamethylenediamine/deca-methylenedicarboxylic acid/octadecamethylenedicarboxylic acid (composition molar ratio: 75/9.5/3/9.5/3) with stirring and heating to dissolve the polyamide pellets. Thereafter, the resultant mixture was subjected to an ultrasonic dispersion treatment. Thus, a dispersion having a solid concentration of 18.0% was obtained which contained the hydrophobized titanium oxide and the copolyamide in a titanium oxide/copolyamide ratio of 3/1 by weight.

The coating fluid for undercoat layer formation thus obtained was applied by dipping onto an aluminum-made cylinder having an outer diameter of 20 mm and a length of 246 mm, and a thickness of 0.80 mm to obtain an undercoat layer in a thickness of 2.0 μm on a dry basis.

Then, a coating fluid for charge-generating layer formation was prepared in the following manner. As a charge-generating material, 20 parts of oxytitanium phthalocyanine having the X-ray diffraction spectrum shown in FIGS. 2 and 280 parts of 1,2-dimethoxyethane were mixed and pulverized for 1 hour with a sand grinding mill to effect a pulverization/dispersion treatment. Subsequently, the pulverized fluid was mixed with a binder solution obtained by dissolving 10 parts of poly(vinyl butyral) (trade name “Denka Butyral” #6000C, manufactured by Denki Kagaku Kogyo K.K.) in a mixed solution of 255 parts of 1,2-dimethoxyethane and 85 parts of 4-methoxy-4-methyl-2-pentanone and with 230 parts of 1,2-dimethoxyethane to prepare a coating fluid A for charge-generating layer formation.

Moreover, as a charge-generating material, 20 parts of oxytitanium phthalocyanine having the X-ray diffraction spectrum shown in FIGS. 3 and 280 parts of 1,2-dimethoxyethane were mixed and pulverized for 4 hours with a sand grinding mill to effect a pulverization/dispersion treatment. Subsequently, the pulverized fluid was mixed with a binder solution obtained by dissolving 10 parts of poly(vinyl butyral) (trade name “Denka Butyral” #6000C, manufactured by Denki Kagaku Kogyo K.K.) in a mixed solution of 255 parts of 1,2-dimethoxyethane and 85 parts of 4-methoxy-4-methyl-2-pentanone and with 230 parts of 1,2-dimethoxyethane to prepare a coating fluid B for charge-generating layer formation.

The coating fluid A for charge-generating layer formation and the coating fluid B for charge-generating layer formation were mixed in a proportion of 1/1 to produce a coating fluid for charge-generating layer formation.

The cylinder on which the undercoat layer had been formed previously was dipped in the dispersion for charge-generating layer coating and formation to form a charge-generating layer in a thickness of about 0.4 μm on a dry basis.

Then, 50 parts of the charge-transporting material composed of isomers containing a compound of the following structure shown in JP-A-2002-80432, 100 parts of the polycarbonate resin (viscosity-average molecular weight: 22,000) according to the invention composed of the repeating unit (1-1), 8 parts of 3,5-di-t-butyl-4-hydroxytoluene as an antioxidant, 0.1 part of tribenzylamine, and 0.05 part of a silicone oil as a leveling agent were mixed into 640 parts of a tetrahydrofuran/toluene (tetrahydrofuran 80% by weight, toluene 20% by weight) mixed solvent to prepare a coating fluid for charge-transporting-layer formation.

The polycarbonate resin was a resin commercially available as a trade name “APEC” from Bayer AG and was used as it was received without purification.

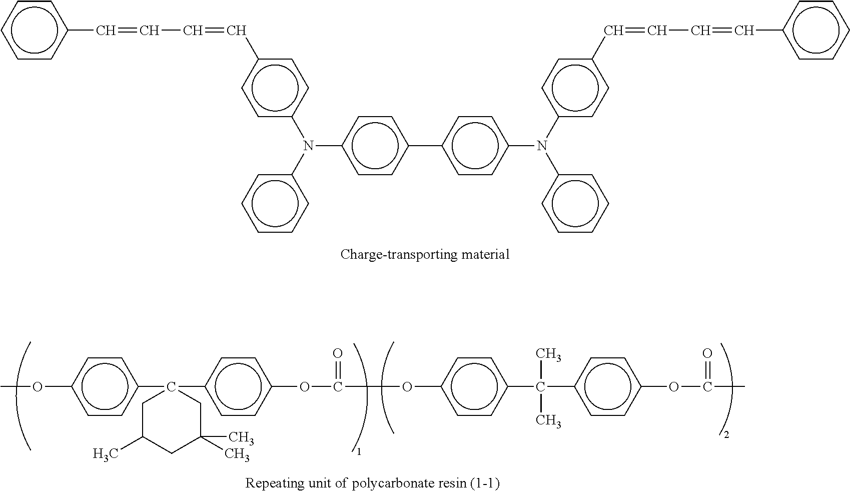

The cylinder on which the charge-generating layer had been formed previously was dipped in the coating fluid for charge-transporting-layer formation for effecting coating to form a charge-generating layer in a thickness of 17 μm on a dry basis. The photoreceptor drum thus obtained is regarded as a photoreceptor Al.

### Example 2

A photoreceptor drum was produced in the same manner as in the case of the photoreceptor 1, except that the polycarbonate resin composed of the repeating unit (1-1) used in the coating fluid for charge-transporting-layer formation of Example 1 was changed to a polycarbonate resin (viscosity-average molecular weight: 22,000) composed of a repeating unit (1-2) having the following structure. The photoreceptor drum thus obtained is regarded as a photoreceptor B1.

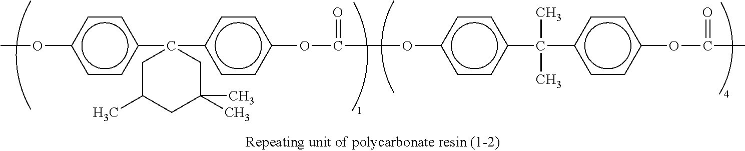

### Comparative Example 1

A photoreceptor drum was produced in the same manner, except that the resin used in the coating fluid for charge-transporting-layer formation in Example 1 was changed to a resin (viscosity-average molecular weight: 20,000) represented by a repeating unit having the following structure. The photoreceptor drum thus obtained is regarded as a photoreceptor C1.

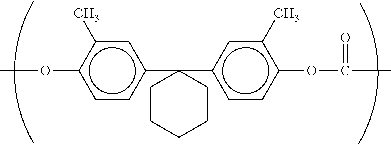

### Comparative Example 2

A photoreceptor drum was produced in the same manner, except that the resin used in the coating fluid for charge-transporting-layer formation in Example 1 was changed to a resin (viscosity-average molecular weight: 20,000) represented by the following structural formula (3). The photoreceptor drum thus obtained is regarded as a photoreceptor D1.

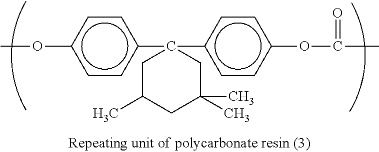

### Comparative Example 3

It was intended to produce a photoreceptor drum in the same manner as in Example 1 except that the resin used in the coating fluid for charge-transporting-layer formation in Example 1 was changed to a polycarbonate resin (viscosity-average molecular weight: 30,000) composed of a repeating unit having the following structure (bisphenol A) but the resin was not dissolved in the tetrahydrofuran/toluene mixed solution. Therefore, the solvent was changed to 100% 1,4-dioxane and a photoreceptor drum E1 was produced.

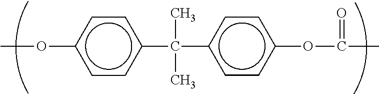

### Comparative Example 4

It was intended to produce a photoreceptor drum in the same manner as in Example 1 except that the resin used in the coating fluid for charge-transporting-layer formation in Example 1 was changed to a mixture of 33 parts of a polycarbonate resin (viscosity-average molecular weight: 20,000) composed of a repeating unit having the structure shown in Comparative Example 2 and 67 parts of a polycarbonate resin (viscosity-average molecular weight: 30,000) composed of a repeating unit (bisphenol A) shown in Comparative Example 3 but the resin was not dissolved in the tetrahydrofuran/toluene mixed solution. Therefore, the solvent was changed to 100% 1,4-dioxane and a photoreceptor drum F1 was produced.

For the photoreceptor drums A1 to F1 produced, the following electrical property test, adhesiveness test, and image property test were performed. The results are summarized in Table 1.

### <Electrical Property Test>

Using an apparatus for electrophotographic-property evaluation produced in accordance with the measurement standards adopted by the Society of Electrophotography of Japan (described in Zoku Denshishashin Gijutsu No Kiso To Oyo, edited by the Society of Electrophotography of Japan, Corona Publishing Co., Ltd., pp. 404-405), each of the above photoreceptor drums was rotated at a constant rotation speed of 120 rpm and subjected to an electrical property evaluation test in which a cycle including charging, exposure, potential measurement, and erase was conducted. In this test, the photoreceptor was charged so as to result in an initial surface potential of −700 V, and exposed at 2.0 μJ/cm² to the monochromatic light of 780 nm obtained by converting the light from a halogen lamp with an interference filter. At 100 milliseconds after the exposure, the surface potential (hereinafter sometimes referred to as VL) was measured. This measurement was made in an environment having a temperature of 25° C. and a relative humidity of 50%. With regard to the VL value, the smaller, the better.

### <Adhesiveness Test>

The surface of each photoreceptor drums was crosshatch-wise incised at intervals of 1 mm (11 lines) in both circumferential and axial directions with a cutting knife to make 10×10 squares. Adhesiveness of the photosensitive layer was tested by attaching an adhesive cellophane tape (manufactured by Nichiban Co., Ltd.) thereon and lifting up the tape slantwise at an angle of 45°. The number of the squares of the photosensitive layer remaining on the substrate was counted. The more the number of the remaining squares of the photosensitive layer is, the better the adhesiveness is.

### <Image Property Test>

A flange was mounted on the photoreceptor drum, which was then set on a monochromatic printer ML-1630 manufactured by Samsung (a blade cleaning method was adopted). A continuous printing was conducted on 1,000 sheets and then a half-tone image was output. In the case where cleaning did not succeed owing to the printing on 1,000 sheets, image fouling was generated by toner passing-through.

TABLE 1

| | | | | | Image |
|---|---|---|---|---|---|
| | Photoreceptor | Resin | VL | Adhesiveness | fouling |
| Example 1 | A1 | (1-1) | 30 | 80 | absent |
| Example 2 | B1 | (1-2) | 31 | 91 | absent |
| Comparative | C1 | bisphenol | 35 | 95 | present |
| Example 1 | | Z | | | |
| Comparative | D1 | (3) | 29 | 12 | absent |
| Example 2 | | | | | |
| Comparative | E1 | bisphenol | 38 | 91 | present |
| Example 3 | | A | | | |
| Comparative | F1 | (3)/bis A | 36 | 47 | absent |
| Example 4 | | | | | |

### Example 3

A photoreceptor drum was produced in the same manner except that the aluminum cylinder used in Example 1 was changed to an aluminum cylinder having an outer diameter of 24 mm, a length of 248 mm, and a thickness of 0.75 mm. The photoreceptor drum thus obtained is regarded as a photoreceptor A2.

### Example 4

A photoreceptor drum was produced in the same manner except that the aluminum cylinder used in Example 2 was changed to an aluminum cylinder having an outer diameter of 24 mm, a length of 248 mm, and a thickness of 0.75 mm. The photoreceptor drum thus obtained is regarded as a photoreceptor B2.

### Comparative Example 5

A photoreceptor drum was produced in the same manner except that the aluminum cylinder used in Comparative Example 1 was changed to an aluminum cylinder having an outer diameter of 24 mm, a length of 248 mm, and a thickness of 0.75 mm. The photoreceptor drum thus obtained is regarded as a photoreceptor C2.

### Comparative Example 6

A photoreceptor drum was produced in the same manner except that the aluminum cylinder used in Comparative Example 2 was changed to an aluminum cylinder having an outer diameter of 24 mm, a length of 248 mm, and a thickness of 0.75 mm. The photoreceptor drum thus obtained is regarded as a photoreceptor D2.

### Comparative Example 7

A photoreceptor drum was produced in the same manner except that the aluminum cylinder used in Comparative Example 3 was changed to an aluminum cylinder having an outer diameter of 24 mm, a length of 248 mm, and a thickness of 0.75 mm. The photoreceptor drum thus obtained is regarded as a photoreceptor E2.

### Comparative Example 8

A photoreceptor drum was produced in the same manner except that the aluminum cylinder used in Comparative Example 4 was changed to an aluminum cylinder having an outer diameter of 24 mm, a length of 248 mm, and a thickness of 0.75 mm. The photoreceptor drum thus obtained is regarded as a photoreceptor F2.

For the photoreceptor drums A2 to F2 produced, the following electrical property test, adhesiveness test, and image property test were performed. The results are summarized in Table 2.

### <Electrical Property Test>

The test was performed in the same manner as in Examples 1 and 2 and Comparative Examples 1 to 4.

### <Adhesiveness Test>

The test was performed in the same manner as in Examples 1 and 2 and Comparative Examples 1 to 4.

### <Image Property Test>

The test was performed in the same manner as in Examples 1 and 2 and Comparative Examples 1 to 4 except that the printer used was changed to a monochromatic printer ML-1610 manufactured by Samsung (a blade cleaning method was adopted).

TABLE 2

| | | | | | Image |
|---|---|---|---|---|---|
| | Photoreceptor | Resin | VL | Adhesiveness | fouling |
| Example 3 | A2 | (1-1) | 32 | 98 | absent |
| Example 4 | B2 | (1-2) | 31 | 100 | absent |
| Comparative | C2 | bisphenol | 36 | 100 | present |
| Example 5 | | Z | | | |
| Comparative | D2 | (3) | 31 | 40 | absent |
| Example 6 | | | | | |
| Comparative | E2 | bisphenol | 40 | 100 | present |
| Example 7 | | A | | | |
| Comparative | F2 | (3)/bis A | 36 | 80 | absent |
| Example 8 | | | | | |

### Comparative Example 9

A photoreceptor drum was produced in the same manner except that the aluminum cylinder used in Example 1 was changed to an aluminum cylinder having an outer diameter of 30 mm, a length of 248 mm, and a thickness of 0.75 mm. The photoreceptor drum thus obtained is regarded as a photoreceptor A3.

### Comparative Example 10

A photoreceptor drum was produced in the same manner except that the aluminum cylinder used in Example 2 was changed to an aluminum cylinder having an outer diameter of 30 mm, a length of 248 mm, and a thickness of 0.75 mm. The photoreceptor drum thus obtained is regarded as a photoreceptor B3.

### Comparative Example 11

A photoreceptor drum was produced in the same manner except that the aluminum cylinder used in Comparative Example 1 was changed to an aluminum cylinder having an outer diameter of 30 mm, a length of 248 mm, and a thickness of 0.75 mm. The photoreceptor drum thus obtained is regarded as a photoreceptor C3.

### Comparative Example 12

A photoreceptor drum was produced in the same manner except that the aluminum cylinder used in Comparative Example 2 was changed to an aluminum cylinder having an outer diameter of 30 mm, a length of 248 mm, and a thickness of 0.75 mm. The photoreceptor drum thus obtained is regarded as a photoreceptor D3.

### Comparative Example 13

A photoreceptor drum was produced in the same manner except that the aluminum cylinder used in Comparative Example 3 was changed to an aluminum cylinder having an outer diameter of 30 mm, a length of 248 mm, and a thickness of 0.75 mm. The photoreceptor drum thus obtained is regarded as a photoreceptor E3.

### Comparative Example 14

A photoreceptor drum was produced in the same manner except that the aluminum cylinder used in Comparative Example 4 was changed to an aluminum cylinder having an outer diameter of 30 mm, a length of 248 mm, and a thickness of 0.75 mm. The photoreceptor drum thus obtained is regarded as a photoreceptor F3.

For the photoreceptor drums A2 to F2 produced, the following electrical property test, adhesiveness test, and image property test were performed. The results are summarized in Table 3.

### <Electrical Property Test>

The test was performed in the same manner as in Examples 1 and 2 and Comparative Examples 1 to 4.

### <Adhesiveness Test>

The test was performed in the same manner as in Examples 1 and 2 and Comparative Examples 1 to 4.

### <Image Property Test>

The test was performed in the same manner as in Examples 1 and 2 and Comparative Examples 1 to 4 except that the printer used was changed to a monochromatic printer ML-6040 manufactured by Samsung (a blade cleaning method is adopted).

TABLE 3

| | | | | | Image |
|---|---|---|---|---|---|
| | Photoreceptor | Resin | VL | Adhesiveness | fouling |
| Comparative | A3 | (1-1) | 32 | 100 | absent |
| Example 9 | | | | | |
| Comparative | B3 | (1-2) | 30 | 100 | absent |
| Example 10 | | | | | |
| Comparative | C3 | bisphenol | 37 | 100 | present |
| Example 11 | | Z | | | |
| Comparative | D3 | (3) | 30 | 90 | absent |
| Example 12 | | | | | |
| Comparative | E3 | bisphenol | 39 | 100 | present |
| Example 13 | | A | | | |
| Comparative | F3 | (3)/bis A | 34 | 100 | absent |
| Example 14 | | | | | |

As is understood from Table 3, in the case of using the photoreceptor drum having an outer diameter of 30 mm, the adhesiveness with the substrate is hardly influenced by the structure of the resin used in the photosensitive layer and thus there is a wide choice of resins for improving image fouling resulting from insufficient cleaning.

However, as is understood from the results in Table 1 where the outer diameter is 20 mm and the results in Table 2 where the outer diameter is 24 mm, the smaller the outer diameter is, the severer the adhesiveness is. Thus, selectable resins are limited.

Hitherto, since downsizing of printers has not attracted attention in the past, a photoreceptor drum having an outer diameter of 30 mm was the mainstream. However, nowadays, it is important to save space in offices and hence it becomes important to made the outer diameter 25 mm or less. For the new problem, sufficient findings are not present and a resin capable of improving adhesiveness with maintaining cleaning properties has not been found. Both of the cleaning properties and the adhesiveness can be first achieved in the invention.

A clear reason for the above results is uncertain but surface properties of the photoreceptor are considered to be one reason. There has been already known a phenomenon that toner-transferring efficiency gets worse at a half-tone part and the reason is explained as follows. That is, in the case of printing a high-density image, a toner layer is formed on the photoreceptor and is easily transferred by the force of electric field. On the other hand, in the case of printing a low-density image, a toner directly adhered to the photoreceptor should be transferred but the adhering force is relatively large. Therefore, it is said that the transferring efficiency extremely gets worse at a half-tone part. For cleaning the toner not transferred, a blade cleaner is necessary but it is impossible to properly clean the toner when the adhering force of the toner is large. This time, when a photoreceptor expected to be able to clean the toner easily is tested, results as expected have been obtained. In addition, for improving the adhesiveness with the substrate with maintaining the cleaning properties, an idea of using a copolycarbonate resin having a specific structure is combined therewith, so that the invention has been accomplished.

This application is based on Japanese patent application JP 2010-138448, filed on Jun. 17, 2010, the entire content of which is hereby incorporated by reference, the same as if set forth at length.

What is claimed is:

1. An electrophotographic photoreceptor comprising a conductive substrate and a photosensitive layer provided thereon, wherein the conductive substrate has a cylindrical shape having an outer diameter of 25 mm or less and the photosensitive layer contains a copolycarbonate resin having a repeating structure represented by the following general formula (1): 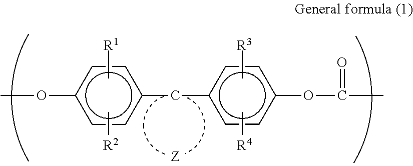
wherein in formula (1), R¹, R², R³ and R⁴ each independently represent a hydrogen atom or an alkyl group having 4 or less carbon atoms, Z forms a saturated cyclic aliphatic alkyl group having 5 to 8 carbon atoms including the carbon atom to be bonded, and the saturated cyclic aliphatic alkyl group has one to three methyl groups as substituent(s).

2. The electrophotographic photoreceptor according to claim 1, wherein the copolycarbonate resin is a copolymer of the repeating structure represented by the above general formula (1) and a repeating structure represented by the following structural formula (2):

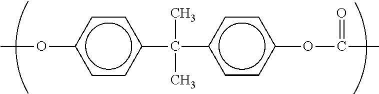

3. The electrophotographic photoreceptor according to claim 2, wherein, in the copolycarbonate resin, the molar ratio of the repeating structure represented by the above structural formula (2) is larger than the molar ratio of the repeating structure represented by the following general formula (1).

4. The electrophotographic photoreceptor according to claim 3, wherein, in the copolycarbonate resin, the molar ratio of the repeating structure represented by the above structural formula (2) is twice or more the molar ratio of the repeating structure represented by the following general formula (1).

5. The electrophotographic photoreceptor according to claim 1, wherein the above general formula (1) is represented by the following structural formula (3):

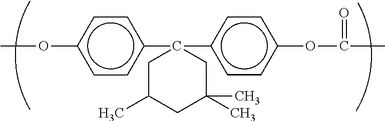

6. The electrophotographic photoreceptor according to claim 1, wherein the outer diameter of the conductive substrate is 22 mm or less.

7. An image-forming apparatus comprising: the electrophotographic photoreceptor according to claim 1; a charging unit which charges the electrophotographic photoreceptor; an exposure unit which exposes the charged electrophotographic photoreceptor to light to form an electrostatic latent image; a developing unit which develops the electrostatic latent image with a toner; and a transfer unit which transfers the toner to a receiving object.

8. An electrophotographic cartridge comprising: the electrophotographic photoreceptor according to claim 1; and at least one member selected from a charging unit which charges the electrophotographic photoreceptor, an imagewise-exposure unit which imagewise exposes the charged electrophotographic photoreceptor to light to form an electrostatic latent image, a developing unit which develops the electrostatic latent image with a toner, a transfer unit which transfers the toner to a receiving object, and a cleaning unit which recovers the toner adherent to the electrophotographic photoreceptor.
